(19) United States
(12) Patent Application Publication
(10) Pub. No.: US 2011/0270719 A1
(43) Pub. Date: Nov. 3, 2011

(54) NETWORK MARKETING SOCIAL NETWORK

(76) Inventors: Anthony Scott Hollars, Tucson, AZ (US); Jeffrey Daniel Thompson, Santa Rosa, CA (US); Jeff Wilhems, Tucson, AZ (US)

(21) Appl. No.: 13/091,044

(22) Filed: Apr. 20, 2011

Related U.S. Application Data
(60) Provisional application No. 61/326,105, filed on Apr. 20, 2010.

(51) Int. Cl. G06Q 99/00; G06Q 30/00

(52) U.S. Cl. 705/30; 705/319

(57) ABSTRACT

A social network and method of using the same is presented. The social network comprises a server comprising a processor and a non-transitory computer readable medium in communication with the processor, where encoded on the computer readable medium is a plurality of subscriber profiles and a plurality of referral networks, where each of the subscriber profiles and referral networks is associated with one of the subscribers of the social network, and where each of the referral networks comprises a total number of referred subscribers referred by the associated subscriber. For each subscriber of the social network, the processor, using the computer readable program code, is configured to calculate a total compensation for the subscriber based upon the associated referral network.

### CROSS-REFERENCE TO RELATED APPLICATION

This application claims priority to, and the benefit of, U.S. Provisional Patent Application Ser. No. 61/326,105, filed on Apr. 20, 2010, titled “NETWORK MARKETING SOCIAL NETWORK,” the entire contents of which are incorporated herein by reference.

### FIELD OF REFERENCE

The present application relates to social networks and, more particularly, to the application of multi-level marketing to social networks.

### BACKGROUND

Social networks are websites that focus on building connections among people who share common interests or activities. Essentially, a social network consists of a representation of each user, generally in the form of a profile, and his or her links to other users of the social network. Social networking sites allow users to share ideas, activities, events, and interests with other users they've connected with.

The success of social networks is dependent upon the number of users of the network and the quality and quantity of material provided by those users. The users, however, are not compensated for their contribution to the social network, causing many users to become unsatisfied. Further, the content provided by users is often mined by the providers of the social network and sold to third parties, creating privacy concerns and causing resentment among users.

### SUMMARY OF THE INVENTION

In one embodiment a social network is presented. The social network comprises a server comprising a processor and a non-transitory computer readable medium in communication with the processor, where encoded on the computer readable medium is a plurality of subscriber profiles and a plurality of referral networks, where each of the subscriber profiles and referral networks is associated with one of the subscribers of the social network, and where each of the referral networks comprises a total number of referred subscribers referred by the associated subscriber. For each subscriber of the social network, the processor, using the computer readable program code, is configured to calculate a total compensation for the subscriber based upon the associated referral network.

In another embodiment an article of manufacture for use with a social network is presented. The article of manufacture includes a processor and a non-transitory computer readable medium in communication with the processor, where a plurality of subscriber profiles and a plurality of referral networks are encoded in the non-transitory computer readable medium, wherein each of the plurality of subscriber profiles and each of the plurality of referral networks are associated with one of the plurality of subscribers, wherein each of the plurality of referral networks comprises a total number of referred subscribers referred by the associated subscriber. The article of manufacture further includes computer readable program code encoded in the non-transitory computer readable medium, where the computer readable program code comprises a series of computer readable program steps to effect, for each of the plurality of subscribers, calculating a total compensation for the subscriber based upon the associated referral network.

In another embodiment a method. The method includes providing a server, where the server includes a processor and a non-transitory computer readable medium in communication with the processor. Encoded in the non-transitory computer readable medium are a plurality of subscriber profiles and a plurality of referral networks, wherein each of the plurality of subscriber profiles and each of the plurality of referral networks are associated with one of the subscribers of the social network, wherein each of the plurality of referral networks comprises a total number of referred subscribers referred by the associated subscriber. The non-transitory computer readable medium further has instructions encoded thereon to calculate a total compensation for each subscriber of the social network based on the associated referral network. The method further includes, for each subscriber of the social network, calculating, using the server, a total compensation for the subscriber based on the associated referral network.

In yet another embodiment, a social network is presented. The social network comprises a server having a processor and a non-transitory computer readable medium in communication with the processor. Encoded in the computer readable medium is computer readable program code and a plurality of subscriber profiles, where each of the plurality of subscriber profiles is associated with a subscriber of the social network, wherein each of the plurality of subscriber profiles comprises a plurality of posts and an email module, wherein the email module is associated with an email address. The processor, using the computer readable program code, is configured to receive a new post from a subscriber of the social network and an identifier identifying one of the plurality of subscriber profiles, forward the post to the email address associated with the subscriber profile identified by the identifier, and post the new post on the subscriber profile identified by the identifier.

In yet another embodiment an article of manufacture for use with a social network is presented. The article of manufacture comprises a processor and a non-transitory computer readable medium in communication with the processor. Encoded in the computer readable medium is computer readable program code and a plurality of subscriber profiles, where each of the plurality of subscriber profiles is associated with a subscriber of the social network, wherein each of the plurality of subscriber profiles comprises a plurality of posts and an email module, wherein the email module is associated with an email address. The computer readable program code comprises a series of computer readable program steps to effect receiving a new post from a subscriber of the social network and an identifier identifying one of the plurality of subscriber profiles, forwarding the post to the email address associated with the subscriber profile identified by the identifier, and posting the new post on the subscriber profile identified by the identifier.

In yet another embodiment a method is presented comprising providing a server having a processor and a non-transitory computer readable medium in communication with the processor. Encoded in the computer readable medium is computer readable program code and a plurality of subscriber profiles, where each of the plurality of subscriber profiles is associated with a subscriber of the social network, wherein each of the plurality of subscriber profiles comprises a plurality of posts and an email module, wherein the email module is associated with an email address. The non-transitory computer readable medium has instructions encoded thereon to receive a new post from a subscriber of the social network and an identifier identifying one of the plurality of subscriber profiles, forward the post to the email address associated with the subscriber profile identified by the identifier, and post the new post on the subscriber profile identified by the identifier. The method further includes receiving, using the server, the new post and the identifier, forwarding, using the server, the post to the email address associated with the subscriber profile identified by the identifier, and posting, using the server, the post to the subscriber profile identified by the identifier.

In yet another embodiment, a social network is presented. The social network comprises a server having a processor and a non-transitory computer readable medium in communication with the processor. Encoded in the computer readable medium is computer readable program code and a plurality of subscriber profiles, where each of the plurality of subscriber profiles is associated with a subscriber of the social network, wherein each of the plurality of subscriber profiles comprises a plurality of posts. The processor, using the computer readable program code, is configured to receive a new post from a subscriber of the social network and an identifier identifying one of the plurality of subscriber profiles, wherein the new post comprises Exchangeable Image File (EXIF) data, create a revised post by removing the EXIF data from the new post, and post the revised post on the subscriber profile identified by the identifier.

In yet another embodiment an article of manufacture for use with a social network is presented. The article of manufacture comprises a processor and a non-transitory computer readable medium in communication with the processor. Encoded in the computer readable medium is computer readable program code and a plurality of subscriber profiles, where each of the plurality of subscriber profiles is associated with a subscriber of the social network, wherein each of the plurality of subscriber profiles comprises a plurality of posts. The computer readable program code comprises a series of computer readable program steps to effect receiving a new post from a subscriber of the social network and an identifier identifying one of the plurality of subscriber profiles, wherein the new post comprises EXIF data, creating a revised post by removing the EXIF data from the new post, and posting the revised post on the subscriber profile identified by the identifier.

In yet another embodiment a method is presented comprising providing a server having a processor and a non-transitory computer readable medium in communication with the processor. Encoded in the computer readable medium is computer readable program code and a plurality of subscriber profiles, where each of the plurality of subscriber profiles is associated with a subscriber of the social network, wherein each of the plurality of subscriber profiles comprises a plurality of posts. The non-transitory computer readable medium has instructions encoded thereon to receive a new post from a subscriber of the social network and an identifier identifying one of the plurality of subscriber profiles, wherein the new post comprises Exchangeable Image File (EXIF) data, to create a revised post by removing the EXIF data from the new post, and to post the revised post on the subscriber profile identified by the identifier. The method further includes receiving, using the server, the new post from a subscriber of the social network and an identifier identifying one of the plurality of subscriber profiles; creating, using the server, the revised post, and posting, using the server, the revised post on the subscriber profile identified by the identifier.

### BRIEF DESCRIPTION OF THE DRAWINGS

Implementations of the invention will become more apparent from the detailed description set forth below when taken in conjunction with the drawings, in which like elements bear like reference numerals.

FIG. 1 is a block diagram depicting an exemplary embodiment of Applicants' social network;

FIG. 2 is a diagram of an exemplary internet-enabled device for use in accessing Applicants' social network;

FIG. 3 is a block diagram of an exemplary embodiment of Applicants' social network environment;

FIG. 4A is a flow chart depicting an exemplary embodiment of attributing a newly referred subscriber to a referral network where referring distributor subscribers are compensated for an unlimited number of direct referrals;

FIG. 4B is a flowchart depicting an exemplary embodiment of attributing a newly referred subscriber to a referral network where referring distributor subscribers are compensated for both directly and indirectly referred subscribers;

FIG. 5 is a flowchart depicting an exemplary embodiment of determining the compensation owed to distributor subscribers based upon the distributor subscriber's referral network; and

FIG. 6 is a flowchart depicting an exemplary embodiment of receiving a response to a post on a subscriber's profile via email and posting the response to the subscriber's profile.

### DETAILED DESCRIPTION

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Many of the functional units described in this specification have been labeled as modules (e.g., modules 232, 234 306, 308, 310, 312, 314, 316, 318, and/or 320) in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically collocated, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Applicants' invention includes a social network employing a network marketing infrastructure to attract and retain subscribers. Generally speaking, network marketing, also referred to as multi-level marketing, is a method of creating a marketing and sales force by compensating promoters of company products not only for the sales they generate, but also for the sales of other promoters they introduce to the company. In Applicants' social network, subscribers to the network receive compensation for referring other subscribers to the network.

More specifically, in certain embodiments a subscriber to Applicants' social network is charged a subscription fee for access to the network. In certain embodiments, the subscriber may pay the entire subscription fee on a periodic basis, such as monthly or annually. In other embodiments, the subscriber may offset the subscription fee by enrolling other new subscribers. Additionally, in certain embodiments once the subscriber has referred a predetermined number of new subscribers, the subscriber is eligible to become a distributor of the social network. As a distributor, the subscriber is entitled to earn additional compensation for new subscribers directly referred and, in certain embodiments, those that are indirectly referred as well. While a subscriber has the option to become a distributor, it should be noted that a subscriber does not have to become a distributor. Applicants' network marketing infrastructure is described more fully below.

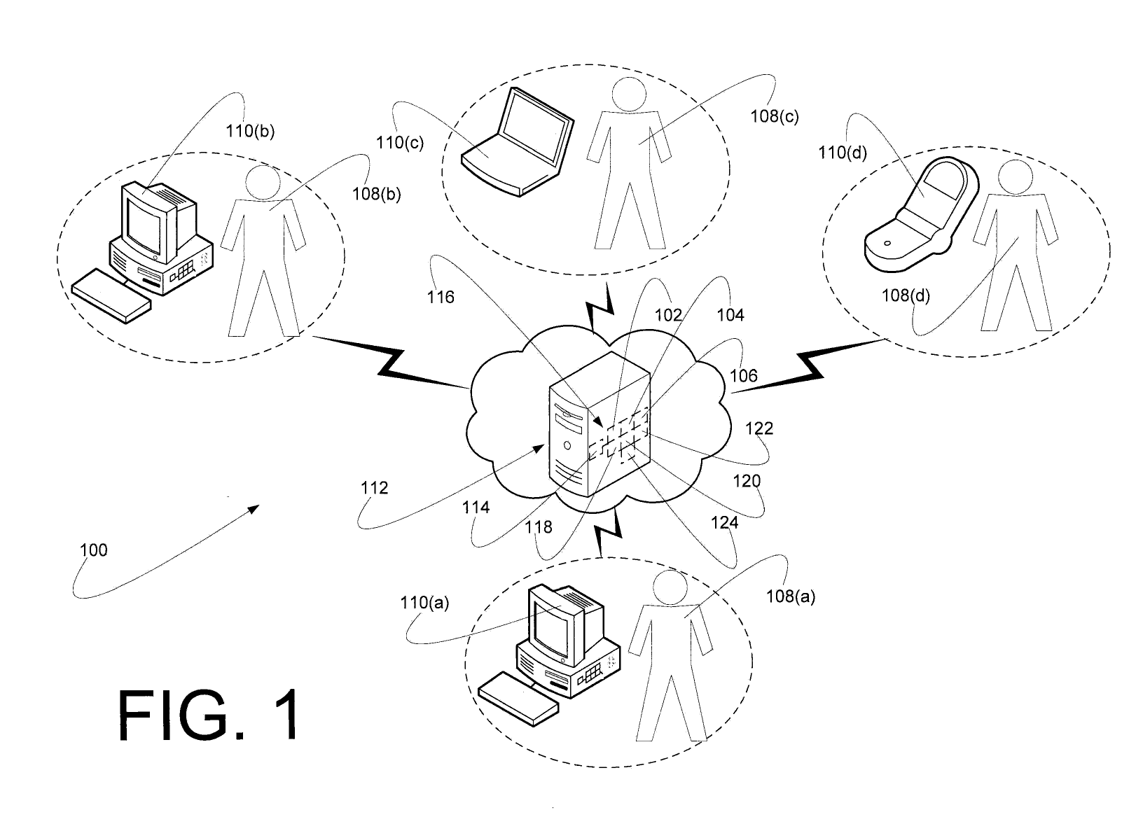

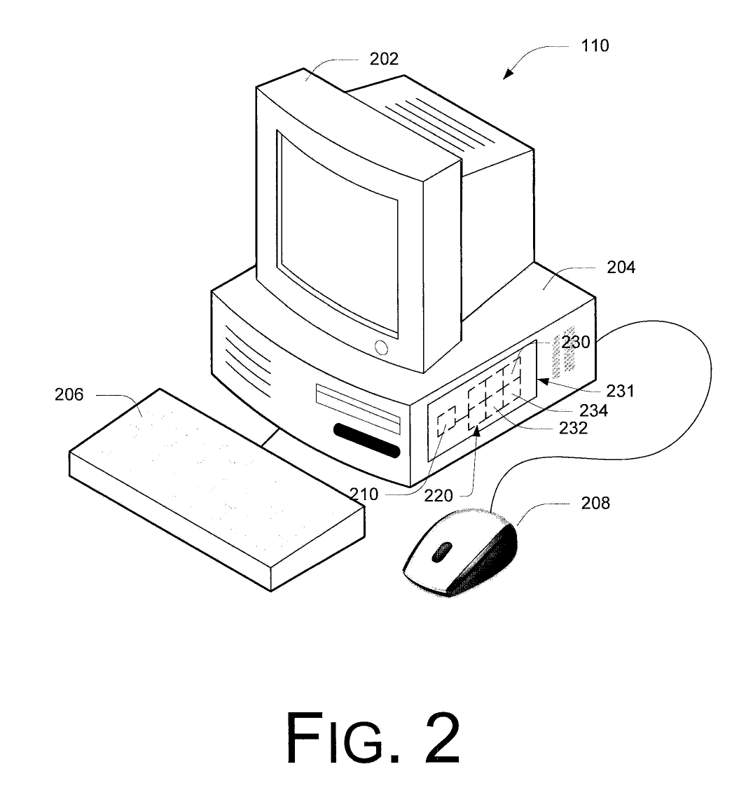

Turning now to FIG. 1, a block diagram is presented depicting an exemplary embodiment of Applicants' social network. In the illustrated embodiment of FIG. 1, a subscriber, such as subscriber 108(a), of Applicants' social network 100 uses an internet-enabled device, such as apparatus 110(a), to access network 100. Apparatus 110(a) may be any device capable of accessing a webpage, such as, and without limitation, a personal computer, laptop, tablet PC, cellular telephone, personal digital assistant (PDA), SmartPhone or similar device. An exemplary embodiment of apparatus 110(a) is depicted in FIG. 2.

As can be seen in FIG. 2, apparatus 110 comprises computing device 204, a visual display device 202 and a data input device, such as for example and without limitation, a keyboard 206 and/or a mouse 208. Computing device 204 comprises controller 231 comprising a programmable processor 210 interconnected via communication links with non-transitory computer readable medium 220, computer readable program code 230 encoded in the non-transitory computer readable medium 220, optional VOIP module 232, and optional “WI-FI” module 234. In certain embodiments, computing device 204, visual display device 202, and data input device are combined into a single hand-held device, such as a tablet PC, laptop computer, cellular telephone, or PDA.

In certain embodiments, visual display device 202 comprises a liquid crystal display (LCD) display, or a plasma display. In other embodiments, visual display device 202 comprises a video projector and screen.

In certain embodiments, non-transitory computer readable medium 220 comprises non-volatile memory. In certain embodiments, non-transitory computer readable medium 220 comprises battery backed up RAM, a magnetic hard disk assembly, an optical disk assembly, and/or electronic memory. By “electronic memory,” Applicant means a PROM, EPROM, EEPROM, SMARTMEDIA, FLASHMEDIA, and the like.

Optional VOIP module 232 implements a Voice over Internet Protocol (VoIP). VoIP is a general term for a family of transmission technologies for delivery of voice communications over IP networks such as the Internet or other packet-switched networks. Internet telephony includes communications services, such as and without limitation voice, facsimile, and/or voice-messaging applications, that are transported via the Internet, rather than the public switched telephone network (PSTN).

Optional WI-FI module 234 comprises a wireless network communication module comprising a wireless network permitting communication with one or more external computers or programmable devices in a network or with point-to-point communications. In certain embodiments, WI-FI module 234 implements one or more of the embodiments of IEEE Specification 802.11 (collectively the “IEEE Specification”). As those skilled in the art will appreciate, the IEEE Specification comprises a family of specifications developed by the IEEE for wireless LAN technology.

The IEEE Specification specifies an over-the-air interface between a wireless client, such as for example apparatus 110(d) (FIG. 1), and a server or between two wireless clients. The IEEE accepted the IEEE Specification in 1997. There are several specifications in the 802.11 family, including (i) specification 802.11 which applies to wireless LANs and provides 1 or 2 Mbps transmission in the 2.4 GHz band using either frequency hopping spread spectrum (FHSS) or direct sequence spread spectrum (DSSS); (ii) specification 802.11a which comprises an extension to 802.11 that applies to wireless LANs and provides up to 54 Mbps in the 5 GHz band using an orthogonal frequency division multiplexing encoding scheme rather than FHSS or DSSS; (iii) specification 802.11b, sometimes referred to as 802.11 High Rate or WI-FI, which comprises an extension to 802.11 that applies to wireless LANS and provides up to about 11 Mbps transmission in the 2.4 GHz band; and/or (iv) specification 802.11g which applies to wireless LANs and provides 20+Mbps in the 2.4 GHz band.

Processor 210 uses computer readable program code 230 to operate controller 231, WI-FI module 234, VOIP module 232, and visual display device 202.

In certain embodiments, internet-enabled apparatus 110 further comprises a microphone. In such embodiments, processor 210 additionally controls the microphone, allowing the subscriber to record audio files for transmission to a server comprising Applicants' social network 100. In such embodiments, the audio recording is stored on a server of network 100 for downloading by other users. In certain embodiments, internet-enabled apparatus 110 further comprises a speaker for listening to audio recordings stored on a server of network 100.

Returning to FIG. 1, subscriber 108(a) uses internet-enabled apparatus 110(a) to access Applicants' social network 100. Data may be transmitted to and from Applicants' social network 100 and subscriber 108(a)'s internet-enabled apparatus 110(a) using optional Wi-Fi module 234, optional VOIP module 232, or any computer network capable of connecting to the internet such as a local-area network (LAN) or wide-area network (WAN).

Applicants' social network 100 comprises server 112 comprising a programmable processor 114 interconnected via a communication link with non-transitory computer readable medium 116, and computer readable program code 118 encoded in non-transitory computer readable medium 116. One of ordinary skill in the art will appreciate that while FIG. 1 depicts a single server, in certain embodiments Applicants' social network may comprise multiple servers without departing from the scope of the present invention.

In certain embodiments, non-transitory computer readable medium 116 comprises non-volatile memory. In certain embodiments, non-transitory computer readable medium 116 comprises battery backed up RAM, a magnetic hard disk assembly, an optical disk assembly, and/or electronic memory. By “electronic memory,” Applicant means a PROM, EPROM, EEPROM, SMARTMEDIA, FLASHMEDIA, and the like.

In the illustrated embodiment of FIG. 1, server 112 further comprises referral database 102, subscriber profile database 104, and account database 106. Referral database 102 stores data regarding both directly and indirectly referred subscribers associated with the referral network of each distributor subscriber to Applicants' social network 100. Account database 106 comprises data regarding an account associated with each distributor subscriber, wherein the account includes the compensation earned by the distributor subscriber based on the number of directly and indirectly referred subscribers associated with the distributor subscriber's referral network. Referral database 102 and distributor account database 106 are discussed in detail below.

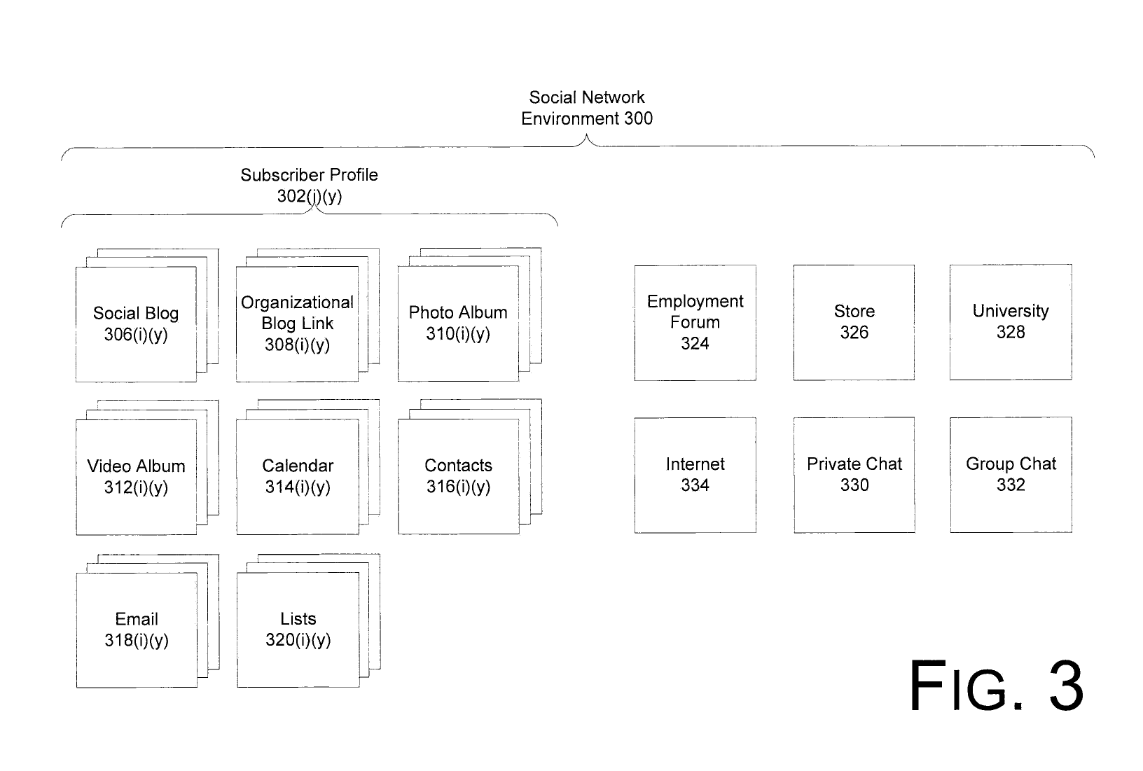

Subscriber profile database 104 comprises each subscriber's online profile within the social network environment of network 100. FIG. 3 depicts a block diagram of Applicants' social network environment 300 including each subscriber profile 302(i).

Within the social network environment 300 of network 100 and as illustrated in FIG. 3, a subscriber, subscriber (i), may have more than one subscriber profile 302(i)(y), where the subscriber allows only specific groups of other subscribers to view each profile 302(i)(y). To do this, the subscriber assigns relationships to other subscribers of Applicants' social network 100. A relationship may be, by way of example and not limitation, “family,” “friend,” “co-worker,” or “client.” In certain embodiments, more than one relationship may be designated for another subscriber such as, by way of example and not limitation, “friend” and “co-worker.” For each profile 302(i)(y), the subscriber then designates groups of other subscribers that are allowed to view the profile. By way of example and not limitation, a subscriber may have one profile, profile 302(i)(y), that is visible only to other subscribers who have been designated as “friends” or “family” and another profile, profile 302(i)(y+1), for subscribers who have been designated as “clients” or “co-workers.”

In certain embodiments, a subscriber may also restrict certain content of each of the subscriber's profiles 306(i)(y) such that it is viewable only by other subscribers having certain designated relationships. By way of example and not limitation, a subscriber may allow other subscribers designated as “friends” and “co-workers” to view the subscriber's profile 306(i)(y). However, the subscriber may allow only those other subscribers designated as “friends” to view certain photos or specific posts on profile 306(i)(y).

In certain embodiments, the default setting of subscriber profile 306(i)(y) is “private”, meaning the profile is not viewable by other subscribers. In such embodiments the subscriber must affirmatively designate the groups of other subscribers that will be allowed to view the subscriber's profile. Likewise, in certain embodiments, each portion of a subscriber's profile and/or content the subscriber posts to his or her profile defaults being private. In such embodiments, the subscriber must affirmatively designate the groups of other subscribers that will be allowed to view the content. As will be appreciated by one of ordinary skill in the art, by having subscriber's profiles and content posted thereon default to not being viewable by others, the subscriber's privacy is better protected as it is less likely that personal information about the subscriber will be inadvertently made public.

As is shown in the illustrated embodiment of FIG. 3, each subscriber profile 302(i) of social network environment 300 comprises a social blog module 306(i), organizational blog links 308(i), photo album module 310(i), video album module 312(i), calendar module 314(i), contacts module 316(i), email module 318(i), and lists module 320(i). Where a subscriber has more than one subscriber profile 302(i)(y), each component of subscriber profile 302(i)(y) may differ. Alternatively, certain components may be shared between the various profiles of a given subscriber. By way of example and not limitation, a given subscriber (i) may have profile 302(i)(y) viewable to subscribers designated as “friends” and profile 302(i)(y+1) viewable to subscribers designated as “family.” However, the content of social blog module 306(i)(y) of subscriber profile 302(i)(y) may be the same as the content of social blog module 306(i)(y+1) of subscriber profile 302(i)(y+1). In other embodiments, a subscriber may not utilize all the modules of profile 302(i)(y) and such non-used modules may therefore not be visible to other subscribers. In other embodiments, a subscriber may have more than one of a given component for a given subscriber profile 302(i)(y). By way of example and not limitation, a subscriber's profile 302(i)(y) may include photo album modules 310(i)(y) through 310(i)(y+4).

In the illustrated embodiment of FIG. 3, social blog module 306 comprises content which includes posts created by a subscriber, such as subscriber 108(a) (FIG. 1), for viewing by other subscribers of Applicants' social network 100. Posts may comprise, by way of example and not limitation, text-based messages, images, video clips, audio clips, or a combination thereof. In certain embodiments, other subscribers having approved designated relationships to subscriber 108(a) can post replies to subscriber 108(a)'s posts

Organizational blog link 308 links to one or more organizational blogs. Organizational blogs are similar to social blogs and each acts as the blog for, by way of example and not limitation, a company, organization, social club, business, etc. In certain embodiments, organizational blog link 308 may link to organizational blogs that a subscriber selects. In such embodiments, the subscriber may participate in the specific organizational blogs linked to by organizational blog link 308. In certain embodiments, the organizational blogs linked to by organizational blog link 308 may be controlled by the subscriber. Where the subscriber controls the blog, the subscriber can designate other subscribers to act as editors or contributors to the subscriber's organizational blog. In such embodiments, subscribers designated as contributors may only contribute content for the organizational blog whereas editors may edit, approve, add or delete content. In certain embodiments, an organizational blog can be public to all subscribers of network 100, or may be limited to subscribers by invitation only. In certain embodiments, a subscriber can designate that post made to an organizational blog also appear on the subscriber's social blog. In certain such embodiments, only subscribers who founded or have control over the social blog may have it's posts also appear on their own social blog.

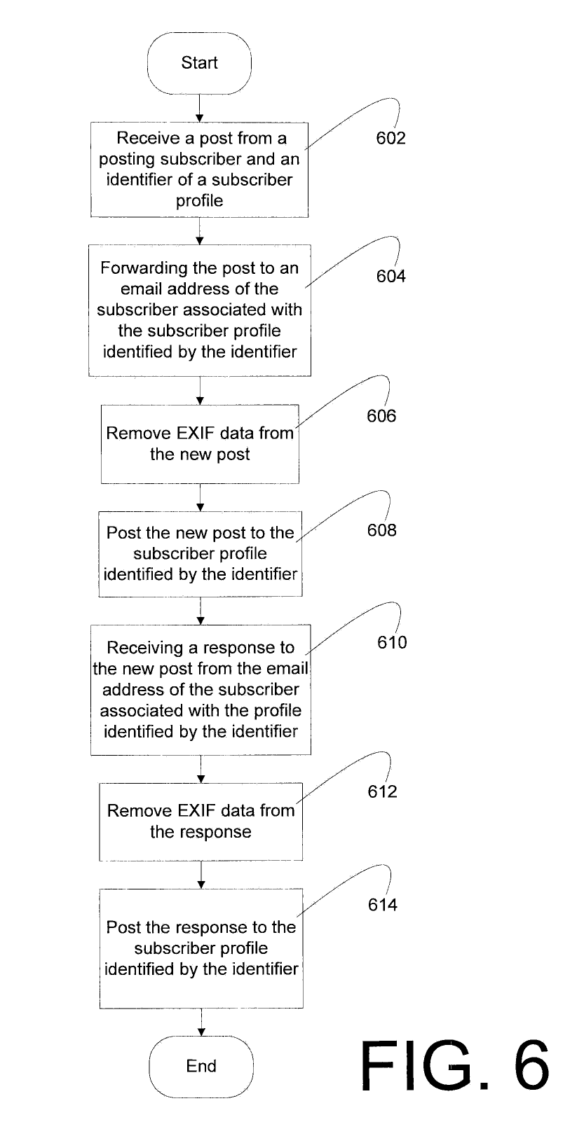

In certain embodiments, posts or comments made to a subscriber's social blog 306(i) or to an organizational blog that the subscriber is linked to may be forwarded as an email to an email address designated by the subscriber, wherein it is then readable using email module 318 and/or an email client of the subscriber's choosing. In certain embodiments, the subscriber can then respond to the post or comment by email. An exemplary flowchart summarizing Applicants' method is illustrated in FIG. 6.

Turning to FIG. 6, a post is received from a subscriber along with an identifier for a subscriber profile, where the post is intended to be posted on the subscriber profile identified by the identifier, as is indicated by block 602. As is indicated by block 604, the post is forwarded as an email to an email address associated with the subscriber profile identified by the identifier. In certain embodiments, the email address is for the subscriber of the profile. In other embodiments, the email address is for another subscriber other than the subscriber of the profile. In such a case the profile may be a group profile and the post is forwarded to the email address of subscribers who are members or fans of the group.

In certain embodiments, where the post includes Exchange Image File (EXIF) data, the EXIF data is automatically removed from data images and video files before being posted to the subscriber profile identified by the identifier, as indicated by blocks 606 and 608. As will be appreciated by one of ordinary skill in the art, EXIF data is automatically stored by digital cameras, including smartphones, and scanners when an image or video file is taken. The EXIF data includes information about the device used to take the image or video file, including camera type, resolution, shutter speed, etc., as well as personal information such as the date and time the image or video was taken. Some devices which have a build-in global positioning system (“GPS”) will further store geographic location about where the picture was taken. As criminals can use the EXIF information to determine an individuals location, including identifying that they are away from their home, the automatic removal of EXIF data increases the privacy and security for users of Applicants' social network.

The subscriber receiving the post via email may then respond to the post by replying via email, as is indicated by block 610. If the response included EXIF data, tin certain embodiments he EXIF data is automatically be removed, as indicated by block 612. The response is posted on the subscriber profile identified by the original identifier, as indicated by block 614. In certain embodiments, the response is additionally posted on another subscriber profile. In certain embodiments, the response includes a second identifier to identify the subscriber profile that the response is to be posted to. In certain embodiments the second identifier differs from the first identifier and thus the response is posted to a different profile than the original post. In such embodiments, a notice may be sent to the subscriber who made the original post to notify him or her that a response was posted on the other profile.

In certain embodiments, a subscriber can further designate to have posts to another subscriber's blog forwarded as email. In certain such embodiments, the subscriber's response is then emailed to the subscriber who made the post or comment. In other such embodiments, the response is then posted to the blog, such as social blog 306 or an organizational blog, wherein it is viewable by other subscribers who are able to read the blog. In certain embodiments the subscriber can chose when responding whether the response is delivered as an email or is posted to the blog.

In certain embodiments, posts may be forwarded as text messages, rather than or in addition to an email message, in the manner described in FIG. 6. In such embodiments, a phone number is associated with the subscriber profile, wherein the test message is sent to the associated phone number. In such embodiments, the recipient may then reply to the post via text message in the same manner as described in FIG. 6 as well.

In certain embodiments, individual blocks described above may be combined, eliminated, or reordered.

In certain embodiments, instructions, such as instructions 118 (FIG. 1), are encoded in non-transitory computer readable medium, such as non-transitory computer readable medium 116 (FIG. 1), wherein those instructions are executed by a processor, such as processor 114 (FIG. 1), to perform one or more of the blocks 602, 604, 606, 608, 610, 612, and 614 recited in FIG. 6.

In yet other embodiments, the invention includes instructions residing in any other computer program product, where those instructions are executed by a computer external to, or internal to, a computing system to perform one or more of the blocks 602, 604, 606, 608, 610, 612, and 614 recited in FIG. 6. In either case the instructions may be encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like.

Returning to FIG. 3, photo album module 310 allows a subscriber to upload digital images for viewing by other subscribers. In certain embodiments, the images are available for viewing, downloading and/or printing by other subscribers, as permitted. In certain embodiments, the images can be associated with other subscribers in Applicants' social network.

Video Album module 312 is similar to photo album 310, and allows uploading video files for viewing by other subscribers, as permitted. As with photo album 310, the uploaded video files can be associated with other subscribers of Applicants' social network.

In certain embodiments, the digital images and video files uploaded to photo album module 310 or video album module 312, respectively, are searchable. In certain embodiments, the subscriber uploading the digital image or video file provides a title or other description which is searchable. In certain embodiments, the subscriber is be given a choice when uploading the digital image or video file regarding whether to make it discoverable to other subscribers using the search feature. In certain embodiments, the subscriber designates which of the groups of other subscribers are able to discover the digital image or video file using the search feature. By way of example and not limitation, a subscriber may upload a video file of his son. Once the video file is uploaded, the subscriber may then be given an option to make the video discoverable by other subscribers using a search feature. If the subscriber decides to make the video file searchable, they may then associate the video file with a title or other tags that can be used by a search engine, such as “Johnny's Birthday” or “Johnny Smith.” The subscriber may then restrict the group of other subscribers who can discover the video file and thereafter view it to only those that have been designated as “friends” or “family.” In certain embodiments this results in the video file being undiscoverable using the search feature to other subscribers without that designation. In other embodiments the video file is discoverable to other subscribers without the correct designation but is not viewable.

One of ordinary skill in the art can perform searches on online content, such as uploaded digital images and video files.

In certain embodiments, a subscriber profile 302(i) additionally includes modules wherein other types of electronic data files maybe uploaded and shared with other subscribers. By way of example and not limitation, in certain embodiments, a subscriber may be able to upload a spreadsheet, word document, presentation, executable, or other type of electronic file. In such embodiments, the subscriber may allow all other subscribers to view the uploaded electronic files or may restrict access to only those having certain designations, such as “friend” or “family.”

Calendar module 314 allows a subscriber to post events, deadlines, meetings, or any other date-related information to an online calendar. In certain embodiments, the calendar has an alarm feature such that a notice will be provided to the subscriber to remind the subscriber of an upcoming event. In such embodiments, the reminder may be in the form of a pop-up window that appears to the subscriber when the subscriber is logged into Applicants' social network 100. In other such embodiments, the reminder is in the form of an email to an email account of the subscriber or a text message to the subscriber's cellular phone. In yet other such embodiments, the reminder may be any other known method for providing notice of an electronically calendared event. In certain embodiments, the calendar may be shared, either entirely and/or by individual event only, with other subscribers. In other embodiments, subscribers can invite other subscribers to events, thereby, when accepted, automatically placing said event into the recipient subscriber's calendar.

Contacts module 316 allows a subscriber to store the contact information for other subscribers of Applicants' social network 100. In certain embodiments, the contact information comprises a link to the profile of the other subscribers. In other embodiments, the contact information comprises subscribers' telephone numbers, email addresses, or physical addresses, or any combination thereof. In certain embodiments, contact 316 further comprises the contact information of non-subscribers of Applicants' social network 100.

Email module 318 is an email client where a subscriber of Applicants' social network 100 can receive and send email to other subscribers. As will be appreciated by one of ordinary skill in the art, an email client is a computer program used to manage an individual's email and include programs such as, and without limitation, Outlook® by Microsoft Corporation and Thunderbird® by Mozilla Foundation. In certain embodiments, email module 318 may additionally be used to send email to non-subscribers of Applicants' social network. In certain embodiments, email sent via email module 218 may be retrieved by the receiving subscriber using a private email client.

In certain embodiments, email sent via email module 318 is forwarded to another email address specified by the receiving subscriber. By way of example and not limitation, a subscriber may specify that all email sent to him through email module 318 is forwarded to a work email address. The subscriber may then receive and reply to the email using whatever email client has been configured to receive his work email.

List module 320 comprises an itemized list created by a subscriber of Applicants' social network 100. A list can include, by way of example and not limitation, to-do items, project tasks, grocery lists, favorite songs lists, recommended reading lists, or a combination thereof. In certain embodiments, a list may be shared and, if desired, modified by other subscribers.

Returning to FIG. 1, in certain embodiments, server 112 further comprises resume and job database 120. In such embodiments, database 120 comprises resumes submitted by subscribers to Applicants' social network 100. As illustrated in FIG. 3, the resumes stored in database 120 are visible to subscribers of network 100 as employment forum 324 of social networking environment 300. Like with the subscriber's profile 302(i), a subscriber can choose to make a resume stored on database 120 as part of employment forum 324 public to all other subscribers of Applicants' social network 100 or only those having certain designated relationships to the subscriber. Other subscribers having job openings or that are in need of services can then search database 120 via employment forum 324 and contact those subscribers who's resumes meet their needs. In certain embodiments, employment forum 324 will additionally include job openings and/or requests for services. In such embodiments, subscribers to Applicants' social network 100 may forward their resumes to the subscriber who posted the job opening or request for service.

As is further illustrated in FIGS. 1 and 3, in certain embodiments server 112 additionally comprises database 122 storing items offered for sale via either store 326 or university 328 of social networking environment 300. Store 326 comprises items offered for sale by subscribers of Applicants' social network 100. University 328 is a subsection of store 326 comprising educational items. In certain embodiments, the items are uploaded by subscribers to either store 326 or university 328. In other embodiments, the items are created using features of Applicants' social network 100. The items offered for sale may include, by way of example and not limitation, photos, videos, podcasts, eBooks, or physical consumer goods. In certain embodiments, the items offered for sale include themes for subscriber profiles. Items offered for sale via store 326 or university 328 are searchable and may be purchased using referral rewards, a credit card, debit card, Pay Pal, or any other manner of purchasing items online.

In the illustrated embodiment of FIG. 1, in certain embodiments server 112 additionally comprises instant messaging client 124 for private chat 330 (FIG. 3) and public chat 332 (FIG. 3) of social networking environment 300. Private chat 330 allows a subscriber to instant message with any other member of Applicants' social network 100. As will be appreciated by one of ordinary skill in the art, instant messaging is a form of real-time communication between individuals using shared clients. The communication may be text-based, video-based, sound-based, or any other means of communicating in real-time. The instant messages engaged in via private chat 330 are private and cannot be viewed by subscribers not party to the session.

Similar to private chat 330, group chat 332 allows subscribers to share messages with all other subscribers present in the chat room. As will be appreciated by one of ordinary skill in the art, a chat room is a website, or part of a website, that provides a venue for communities of users to communicate in real time. In certain embodiments, subscribers of Applicants' social network 100 can designate a chat room as private or public. A public chat room can be entered by any subscriber of Applicants' social network 100. By comparison, private chat rooms, once established by a subscriber, can be accessed by other subscribers by invitation only.

In certain embodiments, Applicants' social network 100 additionally includes internet portal 334. In such embodiments, internet portal 334 is an internet browser, allowing a subscriber to access and search the web pages not associated with Applicants' social network 100 without leaving network 100.

Returning to FIG. 1, Applicants' social network 100 employs a network marketing infrastructure to drive the growth of network 100 and to maintain subscribers. Subscribers, such as subscribers 108(a), 108(b), 108(c), and 108(d), may earn referral rewards for every new subscriber they refer and enroll. In certain embodiments wherein subscribers pay a subscription fee to access network 100, referral rewards may be used to reduce or completely pay for the subscription fee.

In certain embodiments, subscribers may additionally request distributor status for Applicants' social network 100. Distributor subscribers are eligible to earn referral rewards beyond any amount needed to waive the subscription fee. In certain embodiments, to be eligible to be a distributor a subscriber must have referred the number of new subscribers required to waive the subscription fee. In other embodiments, any subscriber may be a distributor regardless of whether they have referred the number of new subscribers required to waive the subscription fee. In certain embodiments, to be a distributor the subscriber must additionally pay a distributor fee. In certain embodiments, all or part of the distributor fee may be donated to a charity.

Compensation paid to distributor subscribers is based upon the number of new subscribers the distributor subscriber has directly referred and enrolled. To refer potential subscribers, a subscriber, such as subscriber 108(a), may contact the potential subscriber directly by, for example and not limitation, talking to them in person, sending a text message or email, or calling them on the telephone. Alternatively, subscriber 108(a) may send a potential subscriber an email using Applicants' social network 100. In such an embodiment, the email may be delivered to a private email account of the potential new subscriber and may contain an identifier identifying subscriber 108(a) as the referring subscriber. The identifier can then be used upon enrollment, as will be discussed in detail below.

If subscriber 108(a) is a distributor then new subscribers referred by subscriber 108(a) become part of subscriber 108(a)'s referral network, wherein the structure of the referral network is based on a distributor compensation plan. The distributor compensation plan may have any form known to network marketing, such as unilevel, matrix, or binary, or may be a hybrid thereof. As will be appreciated by one of ordinary skill in the art, a unilevel plan is one where a distributor subscriber is compensated for an unlimited number of directly referred new subscribers. These new subscribers are considered to be in the distributor subscriber's “frontline” or “first level.” In a matrix plan, only a limited number of directly referred new subscribers can be associated with the first level. Referrals beyond the maximum number of first level positions are associated with lower level positions. Compensation for those referrals associated with lower levels may be less than for those associated with the distributor subscriber's first level. In a binary plan the first level is restricted to two referred subscribers. Excess referred subscribers are associated with levels below the first level.

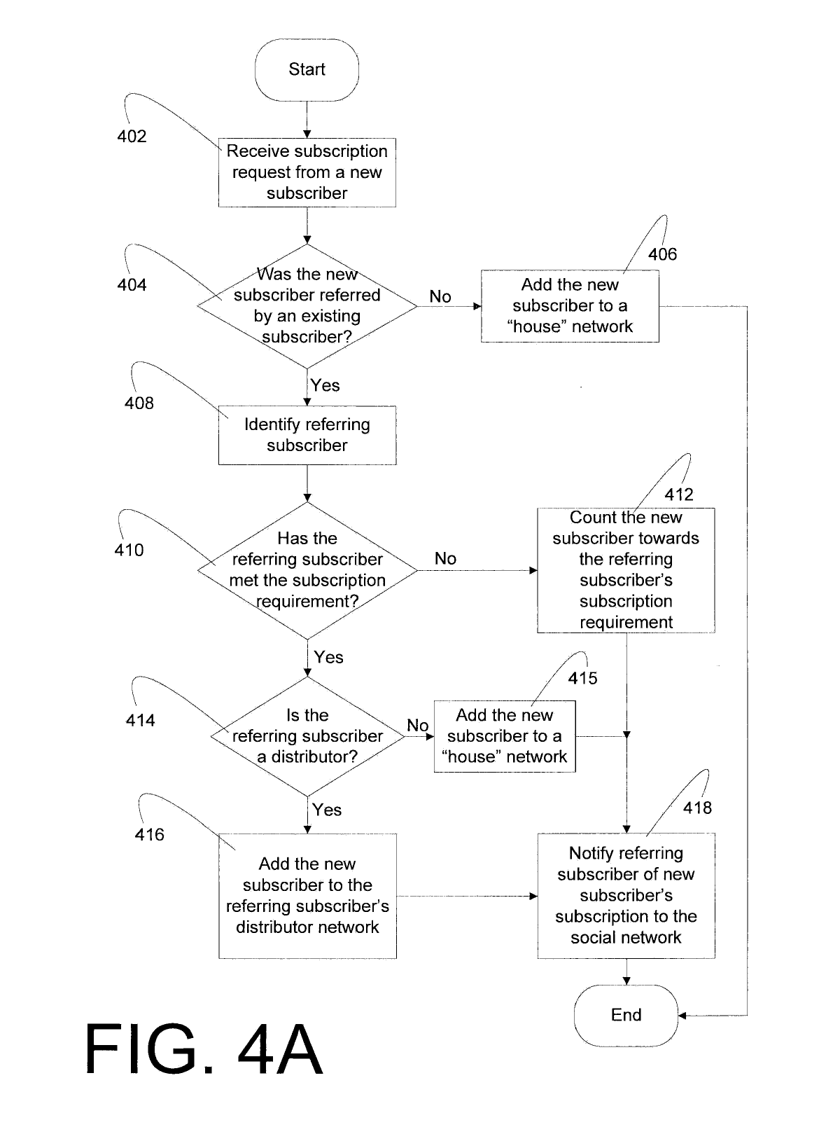

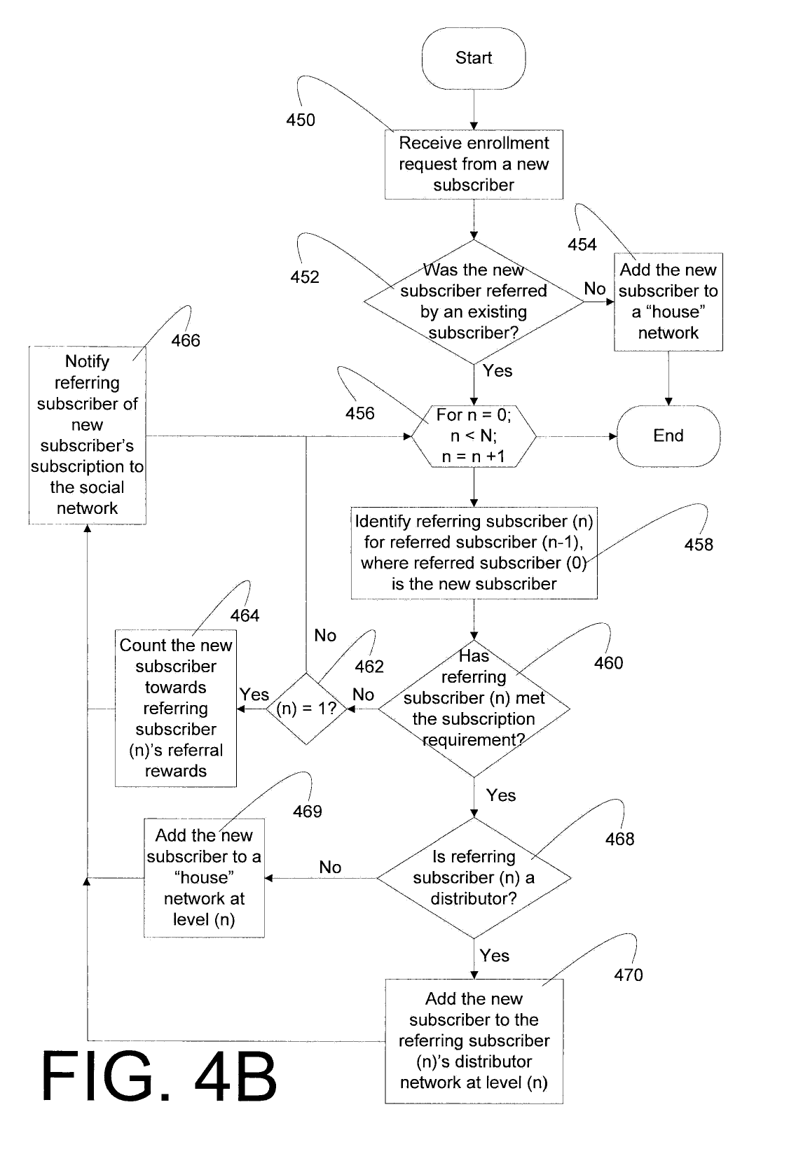

FIG. 4A presents a flow chart depicting an embodiment of attributing a newly referred subscriber to a referral network where referring distributor subscribers are compensated for an unlimited number of direct referrals. In the illustrated embodiment of FIG. 4A, a subscription request is received from a new subscriber, as depicted by block 402. The request may or may not include an identifier identifying a referring subscriber. The identifier may be the name or user name of the referring subscriber. Alternatively, the identifier may be a code given to the referring subscriber by network 100.

Upon receiving the request, Applicants' method determines whether the request includes an identifier identifying a referring subscriber and, if not, in certain embodiments associates the subscriber to a “house” referral network, as indicated by blocks 404 and 406. In certain embodiments, no distributor subscriber is compensated for those subscribers associated with the house referral network. In certain embodiments, if the request does not include an identifier, Applicants' method may request that the new subscriber identify the referring subscriber, if any.

If the request did include an identifier, the associated referring subscriber is identified, as indicated by block 408. As indicated by block 410, it is then determined whether the referring subscriber has met the subscription requirement, if any, such that the referring subscriber has referred the number of new subscribers necessary to have the subscription fee for access to network 100 offset. If the referring subscriber has not, the new subscriber is counted towards the referring subscriber's subscription requirement, as indicated by block 412. In certain embodiments, a notification is provided to the referring subscriber indicating that the new subscriber has joined Applicants' social network 100, as is indicated by block 418.

If the referring subscriber has met the subscription requirement, it is next determined whether the referring subscriber is a distributor, as indicated by block 414. If not, the new subscriber is added to a house referral network, as indicated by block 415, as the referring subscriber has chosen not to participate in Applicants' distributor compensation plan. If the referring subscriber is a distributor, the new subscriber is associated with the referring subscriber's referral network, as indicated by block 416. In certain embodiments, a notification is then provided to the referring subscriber indicating that the new subscriber has joined Applicants' social network 100, as is indicated by block 418.

In certain embodiments, individual blocks described above may be combined, eliminated, or reordered.

In certain embodiments, instructions, such as instructions 118 (FIG. 1), are encoded in non-transitory computer readable medium, such as non-transitory computer readable medium 116 (FIG. 1), wherein those instructions are executed by a processor, such as processor 114 (FIG. 1), to perform one or more of the blocks 402, 404, 406, 408, 410, 412, 414, 416, and 418 recited in FIG. 4A.

In yet other embodiments, the invention includes instructions residing in any other computer program product, where those instructions are executed by a computer external to, or internal to, a computing system to perform one or more of the blocks 402, 404, 406, 408, 410, 412, 414, 416, and 418 recited in FIG. 4A. In either case the instructions may be encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like.

In certain embodiments, a distributor subscriber, such as subscriber 108(a), additionally receives compensation for indirectly referred subscribers, i.e., those new subscribers referred by a subscriber that was directly referred by the distributor subscriber. In such embodiments, the distributor subscriber is compensated differently for indirectly referred subscribers as compared to those that are directly referred. In certain embodiments, the compensation received by the distributor subscriber is based upon the number of steps removed the distributor is from the new subscriber, as illustrated by the level of the distributor subscriber's referral network with which the new subscriber is associated. By way of example and not limitation, new subscriber D may be referred by subscriber C, who was in turn referred by subscriber B, who was in turn referred by subscriber A. Thus, new subscriber D is three steps away from subscriber A and, for compensation purposes, is associated with the third level of subscriber A's referral network. New subscriber D would also be associated with the second level of subscriber B's referral network and the first level of subscriber C's referral network. If the compensation for directly referring a new subscriber is, by way of example and not limitation, $1.00 and is reduced by $0.10 for each level of the referral network, then upon new subscriber D's enrollment, subscriber C would earn $1, subscriber B $0.90, and subscriber A $0.80.

In certain embodiments, there is a defined number of levels a distributor subscriber's referral network may comprise. This limit is referred to as the “depth” of the distributor compensation plan. By way of example and not limitation, a distributor compensation plan that is seven levels deep allows a distributor subscriber to be compensated for those subscribers that are associated with levels 1 through 7 of the distributor subscriber's referral network.

FIG. 4B depicts an exemplary embodiment of attributing a newly referred subscriber to a referring subscriber's referral network where distributor subscribers are compensated for both directly and indirectly referred subscribers. As can be seen in the illustrated embodiment of FIG. 4B, upon receiving a subscription request, Applicants' method determines whether the new subscriber was referred and if not adds the new subscriber to a house network, as indicated by blocks 450, 452, and 454.

If the new subscriber was referred, the new subscriber is associated with multiple distributor subscribers at the appropriate level in the distributor subscriber's referral network as determined by the number of steps removed the new subscriber is to the referring distributor subscriber. As is indicated by blocks 456 and 458, for each level (n) of a distributor's referral network, the referring subscriber (n) of subscriber (n−1) is identified, where subscriber (0) is the new subscriber and where (n) is initially equal to unity (1). As indicated by blocks 460, Applicants' method then determines whether subscriber (n) has met the subscription requirement. If not and if (n) is equal to unity, then the new subscriber is counted towards referring subscriber (n)'s subscription requirement, as indicated by blocks 462 and 464. As will be appreciated by one of ordinary skill in the art, the process described allows only directly referred subscribers to be counted towards a referring subscriber's subscription requirement. In other embodiments indirectly referred subscribers may also be counted towards a referring subscriber's subscription request. In such embodiments, an indirectly referred subscriber may be counted differently towards the subscription requirement than a directly referred subscriber. By way of example and not limitation, for each directly referred subscriber needed to waive the subscription requirement, a subscriber may fulfill the requirement by having two (2) referred subscribers associated with the first level of their referral network, four (4) with the second level, eight (8) with the third level, and so forth.

As indicated by block 466, in certain embodiments a notification is provided to referring subscriber (n) indicating that the new subscriber has joined Applicants' social network 100. The method then returns to block 456 and, if (n) is less than the total number of levels (N) in a referral network, (n) is set to (n+1) and the processes represented by blocks 458 and 460 are repeated.

If referring subscriber (n) has met the subscription requirement, then, as indicated by block 468, Applicants' method determines if referring subscriber (n) is a distributor. If not, the new subscriber is associated with a house referral network at level (n), as indicated by block 469. If referring subscriber (n) is a distributor, the new subscriber is associated with the referring subscriber (n)'s referral network at level (n), as indicated by block 470. In certain embodiments a notification is provided to referring subscriber (n) indicating that the new subscriber has subscribed to network 100, as indicated by block 466. As indicated by block 456, if (n) is less than the total number of levels (N) in a referral network, (n) is set to (n+1) and the processes indicated by blocks 458 through 464 are repeated.

In certain embodiments, individual blocks described above may be combined, eliminated, or reordered.

In certain embodiments, instructions, such as instructions 118 (FIG. 1), are encoded in non-transitory computer readable medium, such as non-transitory computer readable medium 116 (FIG. 1), wherein those instructions are executed by a processor, such as processor 114 (FIG. 1), to perform one or more of the blocks 450, 452, 454, 456, 458, 460, 462, 464, 466, 468, and 470 recited in FIG. 4B.

In yet other embodiments, the invention includes instructions residing in any other computer program product, where those instructions are executed by a computer external to, or internal to, a computing system to perform one or more of the blocks 450, 452, 454, 456, 458, 460, 462, 464, 466, 468, and 470 recited in FIG. 4B. In either case the instructions may be encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like.

In illustration of the method depicted in the exemplary flowchart of FIG. 4B, and not for limitation, a request to subscribe to network 100 may be received by new subscriber (0). Upon receiving the request, Applicants' method may determine that new subscriber (0) was directly referred by subscriber (1) by an identifier in the subscription request. The method then determines whether subscriber (1) has met the subscription request and if not counts new subscriber (0) towards subscriber (1)'s subscription requirement. If subscriber (1) has met the subscription requirement and is a distributor, then new subscriber (0) is associated with subscriber (1)'s referral network at level 1. Applicants' method then determines the subscriber, subscriber (2), who directly referred subscriber (1). If subscriber (2) has met the subscription requirement and is also a distributor, then new subscriber (0) is also associated with subscriber (2)'s referral network at level 2. Applicants' method then determines the subscriber, subscriber (3), who directly referred subscriber (2), and the process is repeated for the number of levels in the distributor compensation plan.

Returning to FIG. 1, distributor subscribers are periodically compensated based upon the referred subscribers associated with each distributor subscriber's referral network. The period may be weekly, monthly, annually, or any other time period. In certain embodiments, the compensation accrued by a subscriber must be at or above a minimum threshold before it will be distributed. By way of example and not limitation, a subscriber may not be compensated until they have accrued $100 dollars or more. In certain embodiments, payment of the compensation is made to a distributor subscriber's account stored in account database 106, wherein each account is associated with an account identifier. In other embodiments, payment of the compensation is made by issuance of a check, prepaid payment card, wire-transfer, or other method of transferring money or rewards.

In certain embodiments, compensation is monetary. In certain such embodiment, the compensation is distributed to a financial account associated with an account identifier, where the distributor subscriber is able to use the funds associated with their account as they would with any other financial account. In such embodiment, funds may be transferred to any other financial account or withdrawn. In certain embodiments, the distributor subscriber is provided a portable consumer payment device associated with their account such as, and without limitation, a debit card, smart card, credit card, or prepaid debit card. In certain embodiments, the distributor subscriber is provided checks associated with their account.

In certain embodiments where the compensation is monetary, a subscriber can designate to have all or a portion of the compensation donated to one or more charities of the subscriber's choice. In such embodiments, the designated charity may then receive a check.

In other embodiments, compensation is in the form of rewards. In such embodiments the rewards may be exchanged for consumer goods. In certain such embodiments, the rewards may be exchanged for consumer goods offered via store 326 or university 328 (FIG. 3). In other such embodiments, the rewards may be exchanged for consumer goods offered by online or physical retailers associated with Applicants' social network 100. In certain embodiments, the rewards can be exchanged for cash. In such an embodiment, the cash may then be transferred to a financial account of the distributor subscriber or paid by providing a check or prepaid debit card to the distributor subscriber.

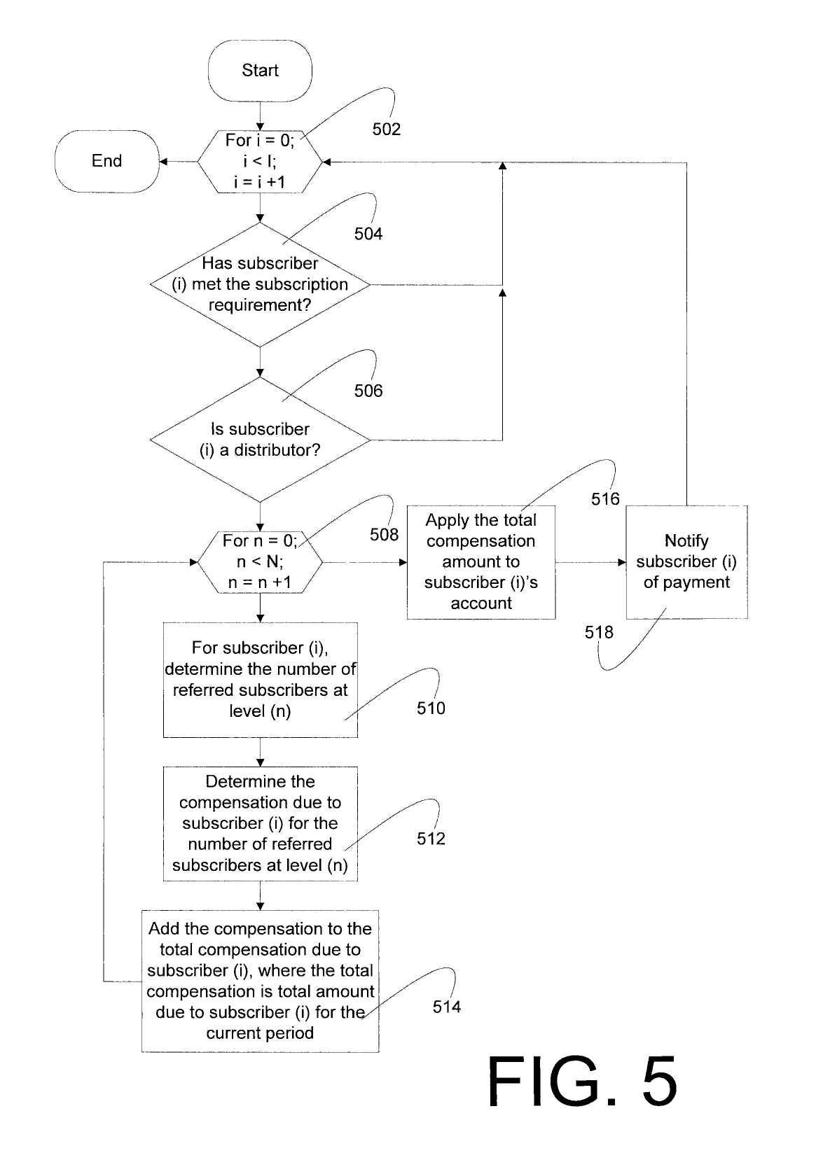

The amount of compensation earned by each distributor subscriber depends on the distributor compensation plan and the number of referred subscribers associated with the distributor subscriber's referral network. FIG. 5 presents a flowchart of an embodiment of determining the compensation owed based on the referral network of FIGS. 4A and 4B. As indicated by blocks 502 and 504 of FIG. 5, for each subscriber (i), Applicants' method verifies that subscriber (i) has met the subscription requirement, if any, where (i) is initially equal to unity. If subscriber (i) has not met the subscription requirement, subscriber (i) is not eligible to be compensated. The method returns to block 502 and, if (i) is less than total number of subscribers (I) to network 100, (i) is set to (i+1) and the process indicated by block 504 is repeated.

If subscriber (i) has met the subscription requirement, then, as indicated by block 506, it is determined whether subscriber (i) is a distributor. If not, subscriber (i) is not eligible to be compensated and the process returns to block 502. If subscriber (i) is a distributor, the compensation owed to subscriber (i) is determined. As indicated by blocks 508 and 510, for each compensation level (n) in the distributor compensation plan, the number of referred subscribers associated with level (n) of subscriber (i)'s referral network is determined, where (n) initially equals unity. Once done, then the compensation due to subscriber (i) for the number of subscribers associated with level (n) of subscriber (i)'s referral network is determined and added to a running total for subscriber (i), as indicated by blocks 512 and 514. The method then returns to block 508 and, if (n) is less than the total levels (N) in the distributor compensation plan, (n) is set to (n+1) and the processes indicated by blocks 510, 512, and 514 are repeated.

Once the total compensation due to subscriber (i) for the relevant period has been determined, the total compensation is applied to the account associated with subscriber (i) and stored in database 106, as indicated by block 516. In certain embodiments, subscriber (i) may then be notified of the payment made to the account, as indicated by block 518. The process then returns to block 502, (i) is increased by unity, and, if (i) is less than (I), blocks 502-518 are repeated.

In certain embodiments, individual blocks described above may be combined, eliminated, or reordered.

In certain embodiments, instructions, such as instructions 118 (FIG. 1), are encoded in non-transitory computer readable medium, such as non-transitory computer readable medium 116 (FIG. 1), wherein those instructions are executed by a processor, such as processor 114 (FIG. 1), to perform one or more of the blocks 502, 504, 506, 508, 510, 512, 514, 516, and 518 recited in FIG. 5.

In yet other embodiments, the invention includes instructions residing in any other computer program product, where those instructions are executed by a computer external to, or internal to, a computing system to perform one or more of the blocks 502, 504, 506, 508, 510, 512, 514, 516, and 518 recited in FIG. 5. In either case the instructions may be encoded in a non-transitory computer readable medium comprising, for example, a magnetic information storage medium, an optical information storage medium, an electronic information storage medium, and the like. “Electronic storage media,” may mean, for example and without limitation, one or more devices, such as and without limitation, a PROM, EPROM, EEPROM, Flash PROM, CompactFlash, SmartMedia, and the like.

In further illustration of the method depicted by FIG. 5, and not for limitation, for each subscriber of Applicants' social network 100, Applicants' method verifies that the subscriber has met the subscription requirement and is a distributor. If so, the subscriber is eligible to be compensated for the subscribers associated with the subscriber's referral network. For each level of the compensation plan (and therefore each level of the referral network), the number of referred subscribers associated with the level is determined. This number is then multiplied by the amount compensated for each referred subscriber associated with the level and added to a running total of the amount due to the distributor subscriber. The total compensation amount is applied to the subscriber's account and the subscriber is notified of the amount they earned that period.

As will be appreciated by one of ordinary skill in the art, the method discussed in connection to FIG. 5 compensates a distributor subscriber for each subscriber associated with the distributor subscriber's referral network, regardless of when the subscriber first joined Applicants' social network. As will further be appreciated by one of ordinary skill in the art, the network marketing infrastructure utilized by Applicants' social network is equally applicable to the situation where a distributor subscriber is only compensated for those referred subscribers who joined Applicants' social network during a given compensation period. Furthermore, in certain embodiments, distributor subscribers are only entitled to be compensated for referred subscribers who continue to be subscribers during a given compensation period. In such embodiments, Applicants' method would further verify that each subscriber associated with the distributor subscriber's referral network is still subscribing to network 100 prior to calculating the compensation owed to the distributor subscriber.

While the preferred embodiments of the present invention have been illustrated in detail, it should be apparent that modifications and adaptations to those embodiments may occur to one skilled in the art without departing from the scope of the present invention.

What is claimed is:

1. A social network, comprising:
a server comprising a processor, a non-transitory computer readable medium in communication with the processor, and computer readable program code encoded in the computer readable medium;
a plurality of subscriber profiles encoded in the computer readable medium, wherein one or more of the plurality of subscriber profiles is associated with a each subscriber of the social network; and
a plurality of referral networks encoded in the computer readable medium, wherein each of the plurality of referral networks is associated with a different subscriber of the social network, wherein each of the plurality of referral networks comprises a total number of referred subscribers;
wherein, for each subscriber of the social network, the processor, using the computer readable program code, is configured to calculate a total compensation for the subscriber based upon the associated referral network.

2. The social network of claim 1, wherein for each subscriber of the social network, the processor, using the computer readable program code, is further configured to calculate the total compensation for the subscriber using the total number of referred subscribers of the associated referral network.

3. The social network of claim 1, wherein each of the plurality of referral networks comprises (N) compensation levels, wherein (N) is greater than or equal to 1, and wherein each of the (N) compensation levels comprises a compensation amount and a number of referred subscribers, wherein the total number of referred subscribers is equal to the number of referred subscribers for all of the (N) compensation levels, wherein the processor, using the computer readable program code is further configured to calculate the total compensation for the subscriber based upon the compensation amount and the number of referred subscribers for each of the (N) compensation levels of the associated referral network.

4. The social network of claim 1, wherein, for each subscriber of the social network, the processor, using the computer readable program code, is further configured to distribute the total compensation calculated for that subscriber.

5. The social network of claim 4, wherein the server further comprises a minimum distribution amount encoded in the computer readable medium, wherein, for each subscriber of the social network, the processor, using the computer readable program code, is further configured to:
compare the total compensation calculated for that subscriber and the minimum distribution amount; and
not distribute the total compensation calculated for the subscriber when the total compensation is less than the minimum distribution amount.

6. The social network of claim 1, wherein the server further comprises a subscription requirement encoded in the computer readable medium, wherein, for each subscriber of the social network, the processor, using the computer readable program code, is further configured to not distribute the total compensation calculated for the subscriber when the subscriber does not meet the subscription requirement.

7. The social network of claim 6, wherein, for each subscriber of the social network, the processor, using the computer readable program code, is further configured to compare the subscription requirement and the total number of referred subscribers of the associated referral network, wherein the subscriber does not meet the subscription requirement when the total number of referred subscribers of the associated referral network is less than the subscription requirement.

8. The social network of claim 1, wherein the processor, using the computer readable program code, is further configured to:
receive an enrollment request from a new subscriber;
identify a referring subscriber who referred the new subscriber; and
increase the total number of referred subscribers of the referral network associated with the referring subscriber by one.

9. The social network of claim 8, wherein each of the plurality of referral networks comprises (N) compensation levels, wherein (N) is greater than or equal to 1, wherein each of the (N) compensation levels comprises a number of referred subscribers, wherein the total number of referred subscribers is equal to the number of referred subscribers for all of the (N) compensation levels, wherein the processor, using the computer readable program code, is further configured to:
identify the (n)th referring subscriber who referred the (n−1) referred subscriber, wherein (n) is initially equal to 1, wherein (n) is less than or equal to (N), wherein (0)th referred subscriber is the new subscriber;
increase the (n)th number of referred subscribers of the (n)th compensation level of the referral network associated with the (n)th referring subscriber by one; and
set (n) equal to (n+1) and repeat said identify and said increase.

10. An article of manufacture comprising a processor, a non-transitory computer readable medium in communication with the processor, computer readable program code to operate a social network encoded in the non-transitory computer readable medium, a plurality of subscriber profiles encoded in the non-transitory computer readable medium, wherein one or more of the plurality of subscriber profiles is associated with each subscriber of the social network, a plurality of referral networks encoded in the non-transitory computer readable medium, wherein each of the plurality of referral networks is associated with a different subscriber, wherein each of the plurality of referral networks comprises a total number of referred subscribers referred by the associated subscriber, the computer readable program code comprising a series of computer readable program steps to effect, for each of the plurality of subscribers, calculating a total compensation for the subscriber based upon the associated referral network.

11. The article of manufacture of claim 10, wherein said computer readable program code to calculate the total compensation further comprises a series of computer readable program steps to effect determining the total compensation for the subscriber using the total number of referred subscribers of the associated referral network.

12. The article of manufacture of claim 10, wherein each of the plurality of referral networks further comprise (N) compensation levels, wherein (N) is greater than or equal to 1, wherein each of the (N) compensation levels comprises a compensation amount and a number of referred subscribers, wherein the total number of referred subscribers is equal to the number of referred subscribers for all of the (N) compensation levels, wherein said computer readable program code to calculate the total compensation further comprises a series of computer readable program steps to effect determining the total compensation for the subscriber based upon the compensation amount and the number of referred subscribers for each of the (N) compensation levels of the associated referral network.

13. The article of manufacture of claim 10, wherein the computer readable program code further comprises a series of computer readable program steps to effect, for each of the plurality of subscribers, distributing the total compensation calculated for that subscriber.

14. The article of manufacture of claim 13, wherein the article of manufacture further comprises a minimum distribution amount encoded in the non-transitory computer readable medium, wherein the computer readable program code further comprises a series of computer readable program steps to effect, for each of the plurality of subscribers:
comparing the total compensation calculated for that subscriber and the minimum distribution amount; and
not distributing the total compensation calculated for that subscriber when the total compensation is less than the minimum distribution amount.

15. The article of manufacture of claim 10, wherein the article of manufacture further comprises a subscription requirement encoded in the non-transitory computer readable medium, wherein the computer readable program code further comprises a series of computer readable program steps to effect, for each of the plurality of subscribers, not distributing the total compensation calculated for the subscriber when the subscriber does not meet the subscription requirement.

16. The article of manufacture of claim 15, wherein the computer readable program code further comprises a series of computer readable program steps to effect, for each of the plurality of subscribers, comparing the subscription requirement with the total number of referred subscribers of the associated referral network, wherein the subscriber does not meet the subscription requirement when the total number of referred subscribers of the associated referral network is less than the subscription requirement.

17. The article of manufacture of claim 10, wherein the computer readable program code further comprises a series of computer readable program steps to effect:
receiving an enrollment request from a new subscriber;
identifying a referring subscriber who referred the new subscriber; and
associating the new subscriber with the referral network associated with the referring subscriber.

18. The article of manufacture of claim 17, wherein said computer readable program code to associate further comprises a series of computer readable program steps to effect increasing the total number of referred subscribers of the associated referral network by one.

19. The article of manufacture of claim 17, wherein each of the referral networks further comprise (N) compensation levels, wherein (N) is greater than or equal to 1, wherein each of the (N) compensation levels comprises a number of referred subscribers, wherein the total number of referred subscribers is equal to the number of referred subscribers for all of the (N) compensation levels, wherein the computer readable program code further comprises a series of computer readable program steps to effect:
identifying the (n)th referring subscriber who referred the (n−1) referred subscriber, wherein (n) is initially equal to 1, wherein (n) is less than or equal to (N), wherein (0)th referred subscriber is the new subscriber;
increasing the (n)th number of referred subscribers of the (n)th compensation level of the referral network associated with the (n)th referring subscriber by one; and
setting (n) equal to (n+1) and repeating said identifying and said increasing.

20. A method comprising:
providing a server comprising a processor, a non-transitory computer readable medium in communication with the processor, a plurality of subscriber profiles encoded in the computer readable medium, wherein one or more of the plurality of subscriber profiles is associated with each subscriber of the social network, and a plurality of referral networks encoded in the computer readable medium, wherein each of the plurality of referral networks is associated with a different subscriber of the social network, wherein each of the plurality of referral networks comprises a total number of referred subscribers, wherein the non-transitory computer readable medium has instructions encoded thereon to calculate a total compensation for each subscriber of the social network based on the associated referral network;
calculating, for each subscriber of the social network, using the server, a total compensation based upon the associated referral network.

21. The method of claim 20, wherein said calculating further comprises determining, using the server, the total compensation for the subscriber using the total number of referred subscribers of the associated referral network.

22. The method of claim 20, wherein each of the plurality of referral networks further comprise (N) compensation levels, wherein (N) is equal to or greater than 1, wherein each of the (N) compensation levels comprises a compensation amount and a number of referred subscribers, wherein the total number of referred subscribers is equal to the number of referred subscribers for all of the (N) compensation levels, wherein said calculating further comprises determining, using the server, the total compensation for the subscriber based upon the compensation amount and the number of referred subscribers for each of the (N) compensation levels of the associated referral network.

23. The method of claim 20, wherein the non-transitory computer readable medium further has instructions encoded thereon to distribute the total compensation calculated for each subscriber of the social network, wherein the method further comprises, for each subscriber of the social network, distributing using the server, the total compensation calculated for that subscriber.

24. The method of claim 23, the server further comprises minimum distribution amount encoded in the non-transitory computer readable medium, wherein the non-transitory computer readable medium further has instructions encoded thereon to compare the total compensation calculated for each subscriber of the social network and the minimum distribution amount and to not distribute the total compensation for that subscriber when the total compensation is less than the minimum distribution amount, the method further comprising, for each subscriber of the social network:
comparing, using the server, the total compensation calculated for that subscriber and the minimum distribution amount; and
not distributing, using the server, the total compensation calculated for that subscriber when the total compensation is less than the minimum distribution amount.

25. The method of claim 20, wherein the server further comprises a subscription requirement encoded in the non-transitory computer readable medium, wherein the non-transitory computer readable medium further has instructions encoded thereon to not distribute the total compensation calculated for each subscriber of the social network when the subscription requirement is not met, the method further comprising, for each subscriber of the social network, not distributing, using the server, the total compensation calculated for that subscriber when the subscriber does not meet the subscription requirement.

26. The method of claim 25, wherein the non-transitory computer readable medium further has instructions encoded thereon to compare the subscription requirement with the total number of referred subscribers of the referral network associated with each subscriber of the social network, wherein the subscriber does not meet the subscription requirement when the total number of referred subscribers of the associated referral network is less than the subscription requirement, the method further comprising, for each subscriber of the social network, comparing, using the server, the subscription requirement with the total number of referred subscribers of the associated referral network.

27. The method of claim 20, wherein the non-transitory computer readable medium further has instructions encoded thereon to receive an enrollment request from a new subscriber, identify a referring subscriber who referred the new subscriber, and associate the new subscriber with the referral network associated with the referring subscriber, the method further comprising:
receiving, using the server, an enrollment request from a new subscriber;
identifying, using the server, the referring subscriber; and
associating, using the server, the new subscriber with the referral network associated with the referring subscriber.

28. The method of claim 27, wherein said associating further comprises increasing the total number of referred subscribers of the associated referral network by one.

29. The method of claim 27, wherein each of the referral networks further comprise (N) compensation levels, wherein (N) is equal to or greater than one, wherein each of the (N) compensation levels comprises a number of referred subscribers, wherein the total number of referred subscribers is equal to the number of referred subscribers for all of the (N) compensation levels, wherein the non-transitory computer readable medium further has instructions encoded thereon to identify the (n)th referring subscriber who referred the (n−1) referred subscriber, increase the (n)th number of referred subscribers of the compensation level of the referral network associated with the (n)th referring subscriber by one, and set (n) equal to (n+1), the method further comprising:
identifying the (n)th referring subscriber who referred the (n−1) referred subscriber, wherein (n) is initially equal to 1, wherein (n) is less than or equal to (N), wherein (0)th referred subscriber is the new subscriber;
increasing the (n)th number of referred subscribers of the (n)th compensation level of the referral network associated with the (n)th referring subscriber by one; and
setting (n) equal to (n+1) and repeating said identifying and said increasing.

30. A social network, comprising:
a server comprising a processor, a non-transitory computer readable medium in communication with the processor, and computer readable program code encoded in the computer readable medium;
a plurality of subscriber profiles encoded in the computer readable medium, wherein one or more of the plurality of subscriber profiles is associated with each subscriber of the social network, wherein each of the plurality of subscriber profiles comprises a different plurality of posts and a different email module, wherein each of the email modules is associated with a different email address;
wherein the processor, using the computer readable program code, is configured to:
receive a new post from a subscriber of the social network and a first identifier identifying a first subscriber profile;
forward the new post to the email address associated with the first subscriber profile; and
post the new post on the first subscriber profile.

31. The social network of claim 30, wherein the processor, using the computer readable program code is further configured to receive, from the email address associated with the first subscriber profile, a response to the new post.

32. The social network of claim 31, wherein the response includes a second identifier identifying a second subscriber profile, wherein the processor, using the computer readable program code is further configured to post the response to the second subscriber profile.

33. The social network of claim 32, wherein the first identifier and the second identifier differ, wherein the processor, using the computer readable program code is further configured to notify the subscriber associated with the second subscriber profile of the response.

34. The social network of claim 32, wherein the processor, using the computer readable program code is further configured to forward the response to the email address associated with the second subscriber profile.

35. The social network claim of 30, wherein the first subscriber profile is further associated with a telephone number, wherein the processor, using the computer readable program code, is configured to:
generate, using the new post, a text message; and
send the text message to the telephone number.

36. An article of manufacture comprising:
a processor, a non-transitory computer readable medium in communication with the processor, computer readable program code for operating a social network encoded in the non-transitory computer readable medium, and a plurality of subscriber profiles encoded in the computer readable medium, wherein one or more of the plurality of subscriber profiles is associated with each subscriber of the social network, wherein each of the plurality of subscriber profiles comprises a different plurality of posts and a different email module, wherein each of the email modules is associated with a different email address;
wherein the computer readable program code comprises a series of computer readable program steps to effect:
receiving a new post from a subscriber of the social network and a first identifier identifying a first subscriber profile;
forwarding the new post to the email address associated with the first subscriber profile; and
posting the new post on the first subscriber profile.

37. The article of manufacture of claim 36, wherein the computer readable program code further comprises a series of computer readable program steps to effect receiving, from the email address associated with the first subscriber profile, a response to the new post.

38. The article of manufacture of claim 37, wherein the response includes a second identifier identifying a second subscriber profile, wherein the computer readable program code further comprises a series of computer readable program steps to effect posting the response on the second subscriber profile.

39. The article of manufacture of claim 32, wherein the first identifier and the second identifier differ, wherein the computer readable program code further comprises a series of computer readable program steps to effect notifying the subscriber associated with the second subscriber profile of the response.

40. The article of manufacture of claim 38, wherein the computer readable program code further comprises a series of computer readable program steps to effect forwarding the response to the email address associated with the second subscriber profile.

41. A method comprising:
providing a server comprising a processor, a non-transitory computer readable medium in communication with the processor, and a plurality of subscriber profiles encoded in the computer readable medium, wherein one or more of the plurality of subscriber profiles is associated with each subscriber of the social network, wherein each of the plurality of subscriber profiles comprises a different plurality of posts and a different email module, wherein each of the email modules is associated with a different email address, wherein the non-transitory computer readable medium has instructions encoded thereon to receive a new post from a subscriber of the social network and a first identifier identifying a first subscriber profile, forward the new post to the email address associated with the first subscriber profile, and post the new post on the first subscriber profile;
receiving, using the server, the new post and the first identifier;
forwarding, using the server, the new post to the email address associated with the first subscriber profile; and
posting, using the server, the new post to the first subscriber profile.

42. The method of claim 41, wherein the non-transitory computer readable medium further has instructions encoded thereon to receive, from the email address associated with the first subscriber profile, a response to the new post, the method further comprising receiving, using the server, the response.

43. The method of claim 42, wherein the response includes a second identifier identifying a second subscriber profile, wherein the non-transitory computer readable medium further has instructions encoded thereon to post the response to the second subscriber profile, wherein the method further comprises posting, using the server, the response to the second subscriber profile.

44. The method of claim 42, wherein the first identifier and the second identifier differ, wherein the non-transitory computer readable medium further has instructions encoded thereon to notify the subscriber associated with the second subscriber profile of the response, the method further comprises notifying, using the server, the subscriber associated with the second subscriber profile of the response.

45. The method of claim 43, wherein the non-transitory computer readable medium further has instructions encoded thereon to forward the response to the email address associated with the second subscriber profile, the method further comprising forwarding, using the server, the response to the email address associated with the second subscriber profile.

46. A social network, comprising:
a server comprising a processor, a non-transitory computer readable medium in communication with the processor, and computer readable program code encoded in the computer readable medium; and
a plurality of subscriber profiles encoded in the computer readable medium, wherein one or more of the plurality of subscriber profiles is associated with each subscriber of the social network, wherein each of the plurality of subscriber profiles comprises a different plurality of posts;
wherein the processor, using the computer readable program code, is configured to:
receive a new post from a subscriber of the social network and an identifier identifying a first subscriber profile, wherein the new post comprises Exchangeable Image File (EXIF) data;
create a revised post by removing the EXIF data from the new post; and
post the revised post on the first subscriber profile.

47. The social network of claim 46, wherein each of the plurality of subscriber profiles further comprises a different plurality of contacts, wherein each contact of the plurality of contacts is a different subscriber of the social network, wherein each contact of the plurality of contacts has been assigned at least one of a plurality of designations by the associated subscriber, wherein each post of the plurality of posts has been assigned at least one of the plurality of designations by the associated subscriber, wherein each post of the plurality of posts is viewable only by each contact of the plurality of contacts having at least one of the same assigned designations as said post, wherein the processor, using the computer readable program code, is further configured to provide a request to the subscriber associated with the first subscriber profile, wherein the request is to assign at least one of the plurality of designations to the revised post.

48. The social network of claim 47, wherein the processor, using the computer readable program code, is further configured to make the revised profile viewable to each contact of the plurality of contacts having at least one of the same assigned designations as said revised post.

49. An article of manufacture comprising:
a processor, a non-transitory computer readable medium in communication with the processor, computer readable program code for operating a social network encoded in the non-transitory computer readable medium, and a plurality of subscriber profiles encoded in the computer readable medium, wherein one or more of the plurality of subscriber profiles is associated with each subscriber of the social network, wherein each of the plurality of subscriber profiles comprises a different plurality of posts;
wherein the computer readable program code comprising a series of computer readable program steps to effect:
receiving a new post from a subscriber of the social network and an identifier identifying a first subscriber profile, wherein the new post comprises Exchangeable Image File (EXIF) data;
creating a revised post by removing the EXIF data from the new post; and
posting the revised post on the first subscriber profile.

50. The article of manufacture of claim 49, wherein each of the plurality of subscriber profiles further comprises a plurality of contacts, wherein each contact of the plurality of contacts is another subscriber of the social network, wherein each contact of the plurality of contacts has been assigned at least one of a plurality of designations by the associated subscriber, wherein each post of the plurality of posts has been assigned at least one of the plurality of designations by the associated subscriber, wherein each post of the plurality of posts is viewable only by each contact of the plurality of contacts having at least one of the same assigned designations as said post, wherein the computer readable program code further comprises a series of computer readable program steps to effect providing a request to the subscriber associated with the first subscriber profile, wherein the request is to assign at least one of the plurality of designations to the revised post.

51. The article of manufacture of claim 50, wherein the computer readable program code further comprises a series of computer readable program steps to effect making the revised profile viewable to each contact of the plurality of contacts having at least one of the same assigned designations as the revised post.

52. A method comprising:
providing a server comprising a processor, a non-transitory computer readable medium in communication with the processor, and a plurality of subscriber profiles encoded in the computer readable medium, wherein one or more of the plurality of subscriber profiles is associated with each subscriber of the social network, wherein each of the plurality of subscriber profiles comprises a plurality of posts, wherein the non-transitory computer readable medium has instructions encoded thereon to receive a new post from a subscriber of the social network and an identifier identifying a first subscriber profile, wherein the new post comprises Exchangeable Image File (EXIF) data, to create a revised post by removing the EXIF data from the new post, and to post the revised post on the first subscriber profile;
receiving, using the server, the new post from a subscriber of the social network and the identifier;
creating, using the server, the revised post; and
posting, using the server, the revised post on the first subscriber profile.

53. The method of claim 52, wherein each of the plurality of subscriber profiles further comprises a different plurality of contacts, wherein each contact of the plurality of contacts is another subscriber of the social network, wherein each contact of the plurality of contacts has been assigned at least one of a plurality of designations by the associated subscriber, wherein each post of the plurality of posts has been assigned at least one of the plurality of designations by the associated subscriber, wherein each post of the plurality of posts is viewable only by each contact of the plurality of contacts having at least one of the same assigned designations as said post, wherein the non-transitory computer readable medium further has instructions encoded thereon to effect providing a request to the subscriber associated with the first subscriber profile, wherein the request is to assign at least one of the plurality of designations to the revised post, the method further comprising providing, using the server, the request to the subscriber associated with the first subscriber profile.

54. The method of claim 50, wherein the non-transitory computer readable medium further has instructions encoded thereon to effect making the revised profile viewable to each contact of the plurality of contacts having at least one of the same assigned designations as the revised post, the method further comprising making, using the server, the revised profile viewable to each contact of the plurality of contacts having at least one of the same assigned designations as the revised post.

55. A social network, comprising:
a server comprising a processor, a non-transitory computer readable medium in communication with the processor, and computer readable program code encoded in the computer readable medium; and
a plurality of subscriber profiles encoded in the computer readable medium, wherein one or more of the plurality of subscriber profiles is associated with each subscriber of the social network, wherein each of the plurality of subscriber profiles comprises a different plurality of contacts, wherein each contact of the plurality of contacts is another subscriber of the social network, wherein each contact of the plurality of contacts has been assigned at least one of a plurality of designations by the subscriber associated with the subscriber profile;
wherein the processor, using the computer readable program code, is configured, for each subscriber profile, to:
receive a request to add a new contact to the plurality of contacts associated with the subscriber profile and at least one of the plurality of designations;
add the new contact to the plurality of contacts associated with the subscriber profile; and
assign the at least one of the plurality of designations to the new contact.

56. The social network of claim 55, wherein each of the plurality of subscriber profiles further comprises a different plurality of posts, wherein the associated subscriber has assigned at least one of the plurality of designations to each post of the plurality of posts, wherein each post of the plurality of posts is viewable by each contact of the associated plurality of contacts that has been assigned at least one of the same designations as the post.

57. An article of manufacture comprising:
a processor, a non-transitory computer readable medium in communication with the processor, computer readable program code for operating a social network encoded in the non-transitory computer readable medium, and a plurality of subscriber profiles encoded in the computer readable medium, wherein one or more of the plurality of subscriber profiles is associated with each subscriber of the social network, wherein each of the plurality of subscriber profiles comprises a different plurality of contacts, wherein each contact of the plurality of contacts is another subscriber of the social network, wherein each contact of the plurality of contacts has been assigned at least one of a plurality of designations by the subscriber associated with the subscriber profile;
wherein the computer readable program code comprising a series of computer readable program steps to effect:
receiving a request to add a new contact to the plurality of contacts associated with the subscriber profile and at least one of the plurality of designations;
adding the new contact to the plurality of contacts associated with the subscriber profile; and
assigning the at least one of the plurality of designations to the new contact.

58. The article of manufacture of claim 57, wherein each of the plurality of subscriber profiles further comprises a different plurality of posts, wherein the associated subscriber has assigned at least one of the plurality of designations to each post of the plurality of posts, wherein each post of the plurality of posts is viewable by each contact of the associated plurality of contacts that has been assigned at least one of the same designations as the post.

59. A method comprising:
providing a server comprising a processor, a non-transitory computer readable medium in communication with the processor, and a plurality of subscriber profiles encoded in the computer readable medium, wherein one or more of the plurality of subscriber profiles is associated with each subscriber of the social network, wherein each of the plurality of subscriber profiles comprises a different plurality of contacts, wherein each contact of the plurality of contacts is another subscriber of the social network, wherein each contact of the plurality of contacts has been assigned at least one of a plurality of designations by the subscriber associated with the subscriber profile, wherein the non-transitory computer readable medium has instructions encoded thereon to receive a request to add a new contact to the plurality of contacts associated with the subscriber profile and at least one of the plurality of designations, add the new contact to the plurality of contacts associated with the subscriber profile, and assign the at least one of the plurality of designations to the new contact;
receiving, using the server, the request and the at least one of the plurality of designations;
adding, using the server, the new contact to the plurality of contacts associated with the subscriber profile; and
assigning, using the server, the at least one of the plurality of designations to the new contact.

60. A social network, comprising:
a server comprising a processor, a non-transitory computer readable medium in communication with the processor, and a computer readable program code encoded in the computer readable medium; and
a plurality of subscriber profiles encoded in the computer readable medium, wherein one or more of the plurality of subscriber profiles is associated with each subscriber of the social network, wherein each of the plurality of subscriber profiles comprises a different plurality of posts;
wherein the processor, using the computer readable program code, is configured to:
receive a new post from a subscriber of the social network and a first identifier identifying a first subscriber profile;
generate, using the new post, a text message;
send the text message to a telephone number associated with the first subscriber profile; and
post the new post on the first subscriber profile.

61. The social network claim of 60, wherein at least one of the plurality of posts is a video file, wherein the processor, using the computer readable program code, is configured to play the video file.

62. An article of manufacture comprising:
a processor, a non-transitory computer readable medium in communication with the processor, computer readable program code encoded in the non-transitory computer readable medium, and a plurality of subscriber profiles encoded in the computer readable medium, wherein one or more of the plurality of subscriber profiles is associated with each subscriber of the social network, wherein each of the plurality of subscriber profiles comprises a different plurality of posts,
wherein the computer readable program code comprising a series of computer readable program steps to effect:
receiving a new post from a subscriber of the social network and a first identifier identifying a first subscriber profile;
generating, using the new post, a text message;
sending the text message to a telephone number associated with the first subscriber profile; and
posting the new post on the first subscriber profile.

63. The article of manufacture of claim 62, wherein at least one of the plurality of posts is a video file, wherein the computer program code further comprises a series of computer readable program steps to effect playing the video file.

64. A method comprising:
providing a server comprising a processor, a non-transitory computer readable medium in communication with the processor, and a plurality of subscriber profiles encoded in the computer readable medium, wherein one or more of the plurality of subscriber profiles is associated with each subscriber of the social network, wherein each of the plurality of subscriber profiles comprises a different plurality of posts, wherein the non-transitory computer readable medium has instructions encoded thereon to receive a new post from a subscriber of the social network and a first identifier identifying a first subscriber profile, generate, using the new post, a text message, send the text message to a telephone number associated with the first subscriber profile, and post the new post on the first subscriber profile,
receiving, using the server, the new post and the first identifier;
generating, using the server, the text message based on the new post;
sending, using the server, the text message to the telephone number; and
posting, using the server, the new post on the first subscriber profile.

65. The method claim 64, wherein at least one of the plurality of posts is a video file, wherein the non-transitory computer readable medium further has instructions encoded thereon to play the video file, the method further comprising playing, using the server, the video file.
